(19) United States
(12) Patent Application Publication
(10) Pub. No.: US 2019/0021455 A1
(43) Pub. Date: Jan. 24, 2019

(54) ADJUSTABLE SILICONE WRIST BAND AND KIT

(71) Applicant: Kimberly Valenti, Brooklyn, NY (US)

(72) Inventor: Kimberly Valenti, Brooklyn, NY (US)

(21) Appl. No.: 16/041,751

(22) Filed: Jul. 21, 2018

Related U.S. Application Data
(60) Provisional application No. 62/536,355, filed on Jul. 24, 2017.

(51) Int. Cl. A44C 5/00; A44C 5/20

(52) U.S. Cl. CPC A44C 5/0007; A44C 5/2071; A61C 19/00; A44C 5/0084; A44C 5/0053

(57) ABSTRACT

The invention comprises an assortment of apparatuses to magnetically tether a dental hygienist's hand to the utility tubes and hoses commonly found in a dental office. In a preferred embodiment, this consists of an adjustable silicone utility band containing a magnet which is worn by the hygienist. This tethers him or her to a utility hose or tube, which has a clasp that contains a reciprocal magnet. In other embodiments, the invention comprises rings or fingergrips which contain magnets that tether to the utility hose or tube via the magnetized clasp.

### CROSS-REFERENCE TO RELATED APPLICATION

This application claims benefit to U.S. Provisional Patent Application No. 62/536,355, filed on Jul. 24, 2017.

### BACKGROUND OF THE INVENTION

### 1. Field of Invention

The present invention generally relates to adjustable silicone wrist bands used for health and hygiene professionals to affix utility cords to the practitioner's wrist or forearm. These utility cords include cables, hoses, tubing, and the like which are commonly attached to equipment utilized by health professionals, such as dentists, hygienists, and assistants. Although the present invention comprises an entire new category of adjustable silicone wrist bands, in a preferred embodiment, the adjustable silicone utility band incorporates interchangeable clasps tethered by magnets.

### 2. Description of Related Art

Many health professionals regularly practice their art despite heavy and cumbersome cords and cables around them. For years, these health professionals had no choice but to hold these cords and cables in place while simultaneously treating patients.

For instance, dental health hygienists would wrap the cavitron tubes around their neck and secure it with their working hands. This caused great stress which made it difficult to focus one's attention on the person being treated. Further, it fatigued the finger, hands, and the arms with which the practitioner needed to treat the patient.

One product on the market, the CordEze (R) management tool, attempts to alleviate these concerns and is described in U.S. Design Pat. No. D818,350 to Dencek.

However, this design has many drawbacks. In particular, it is not adjustable and designed for only one position and angle of the cord. It does not allow for any movement or rotation of the cord clip.

Further, it is difficult to put on with one hand and takes a great amount of time. The clip is too big and not adjustable for all size cords. It cannot be turned on the wrist to adjust for the angle of securement. The CordEze (R) is stiff, uncomfortable and one cannot use it for either dental hoses or tubes, such as dental unit high speed or low speed handpieces.

Further, it is difficult to place the utility cord inside the CordEze (R) wrist band. It is also painful when pressed down when the cord is pushed. Further, the CordEze (R) wrist band is not a hands-free bracelet and can get contaminated due to the constantly adjusting cord and also when removing the cord from the wrist band.

Further, due to the CordEze (R)'s elongated clip, it holds a large portion of the utility cord down to the wrist forcing the cord slack inward, which both inconveniences and distracts the health professional. Further, due to the lack of adjustability in the clip size, cords frequently slide through the clip, which shortens the cord and causes more pull. Taken together, these drawbacks require the practitioner to readjust the cord every few minutes.

Finally, cleaning the CordEze (R) is difficult as one cannot reach inside the clip and it is painful to the fingers while trying to clean.

The current invention alleviates many of these concerns over the prior art.

### SUMMARY OF THE INVENTION

A means for magnetically tethering a hand to a utility tube or hose, comprising:

(a) an adjustable silicone wrist band containing at least one magnet
(b) a clasp secured on the utility tube containing at least one magnet

A kit comprising:

(a) at least one adjustable silicone wrist band, and
(b) at least one clasp.

The kit of [0013] wherein the adjustable wrist band contains at least one magnet.

The kit of [0013] wherein the clasp contains at least one magnet.

The foregoing, and other features and advantages of the invention, will be apparent from the following, more particular description of the preferred embodiments of the invention and the claims.

### BRIEF DESCRIPTION OF THE DRAWINGS

FIG. 1 depicts variants of the U-shaped clasp various magnets clasp. These include a flat magnet (FIGS. 1A and 1B), inverted-sphere magnet (FIGS. 1C and 1D), spherical magnet (FIGS. 1E and 1F), and clasps without the magnet (FIGS. 1G and 1H).

FIG. 2 depicts a pronged-clasp with a flat magnet.

FIG. 3 depicts the attachment of the bracelet to both the dental utility cord and dental utility hose.

FIG. 4 depicts the association of the clasp with an inverted-sphere magnet with the bracelet.

FIG. 5 depicts the association of the clasp with a spherical magnet with the bracelet.

FIG. 6 depicts a variant of the magnetic bracelet with a pin.

FIG. 7 depicts two variants of the magnetic bracelet with magnets embedded throughout the magnet. These include spherical magnets (FIG. 7A) and rectangular magnets (FIG. 7B).

FIG. 8 depicts two perspectives of a magnetic silicone ring, including the frontal view (FIG. 8A) and the lateral view (FIG. 8B).

FIG. 9 depicts two variants of a magnetic silicone ring, including one with a thick finger grip (FIG. 9A) and one with a thin finger grip (FIG. 9B).

FIG. 10 depicts the placement of a magnet embedded within a silicone ring.

FIG. 11 depicts two variants of a magnetic ring with teeth-reinforced openings. In FIG. 11A, the teeth-reinforced opening is along the same axis of the finger hold and in FIG. 11B, the teeth-reinforced opening is perpendicular to the axis of the finger hold.

FIG. 12 depicts two perspectives of a finger-hold with a flat magnet secured to its top. The two views are a frontal view (FIG. 12A) and a lateral view (FIG. 12B).

FIG. 13 depicts a perspective view of the finger support with a magnet in use by a dental hygienist.

### DETAILED DESCRIPTION OF PREFERRED EMBODIMENTS

The present invention is magnetic securements for health and hygiene professionals to affix utility cords to the practitioner's hand, wrist, or forearm via adjustable silicone wristbands, rings, or fingerholds.

These utility cords include cables, hoses, tubing, and the like which are commonly attached to equipment utilized by health professionals, such as dentists, hygienists, and assistants.

Interchangeable Magnetic Clasps

The invention utilizes interchangeable magnetic clasps.

Each clasp is made of a thin metal surrounded by silicone. Each clasp is secured to a magnet. These clasps are open on one side to place and hold hoses, tubings, cords or cables, or the like commonly found in dentist offices.

In a preferable embodiment, the clasps are made of a strong, but bendable metal which allows for them to be squeezed open or closed, depending on the preference of the dental hygienist. The clasps can be U-shaped and open to allow removal from the cord. Alternatively, the clasps be squeezed closed to fully secure with the cord or hose.

In a preferred embodiment, the thin metal enclosed by silicone is made of a small, pliant, and bendable metal to allow for the dental hygienist operator to close the clasp around the cord or hose.

The clasps may either be U-shaped or pronged-shaped.

In another embodiment, embossed silicone is used on the inner side of the clasp for extra grip.

In another embodiment, the clasp has a magnet permanently attached to its ventral side, making it one piece. In a preferred embodiment, the magnet is fully embedded under the same silicone as the clasp.

The magnet secured to the clasp may be chosen from a number of shapes, including an inverted-sphere, a circular flat surface (discus-shaped), or spherical.

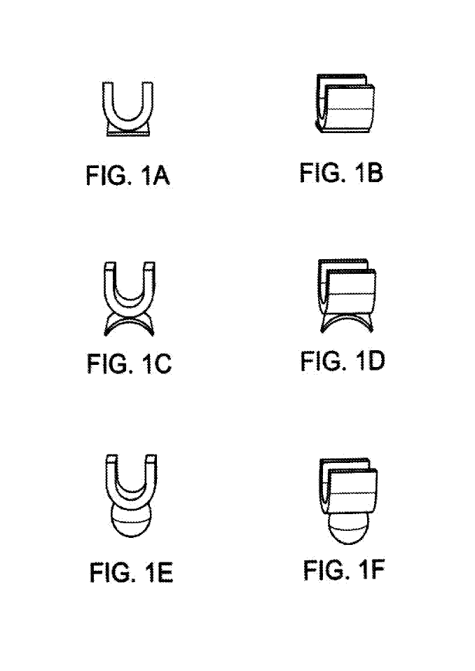

Reference is made to FIG. 1, which depicts variants of a U-shaped clasp with various magnets. These include a flat magnet (FIGS. 1A and 1B), inverted-sphere magnet (FIGS. 1C and 1D), spherical magnet (FIGS. 1E and 1F), and clasps without the magnet (FIGS. 1G and 1H).

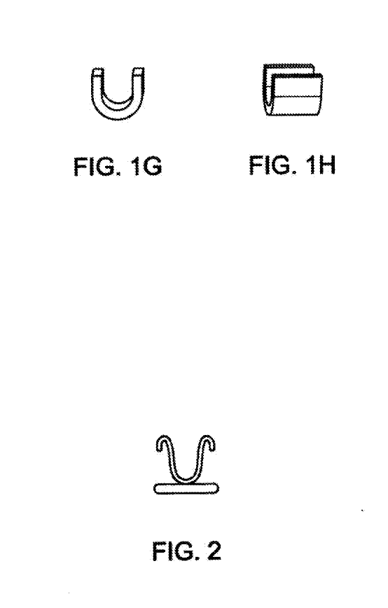

FIG. 2 depicts a pronged-clasp with a flat magnet.

In a preferred embodiment, the clasp is U-shaped which allows the operator to close the clasp without hurting his or her fingers.

The clasps can vary in their size circumference to properly fit the hoses, tubing, cords, and cables.

The hose or tubing of the dental unit handpieces are larger in size and approximately 12 mm to 13 mm in diameter and cannot be held at the top of the wrist for connection to wristband.

The high-speed suction used by the dental assistants has an even larger tube approximately 17 to 18 mm in diameter. In this instance the wristband may be moved up to the forearm due to this particular tube being less flexible.

In a preferred embodiment, the clasp size fits the precise hose, tubing, cord, or cable which the dental hygienist is employing at a particular moment.

There will be at least three magnetic clasps for the dental hygienic cords and at least two for the dental hygienic hoses. The clasps for cords are approximately 5 mm diameter, 6 mm diameter and 7 mm diameter.

The two hose clasp will be approximately 12 mm diameter and 17 mm diameter.

In another preferred embodiment, the clasp is adjoined to a high speed suction tube, which is approximately 36 mm in inner circumference.

In a preferred embodiment, the clasps are tightly secured to their respective hoses, tubing, cords, or cables.

In another embodiment, the magnet can be a half sphere protruding outward from the wrist band. This allows for more angles and positions of placement and rotation of the connecting hoses and cords.

In another embodiment, the magnet can be a raised half sphere or flat magnet, depending on the preference of the operator.

In a preferred embodiment, the shape of the magnet of the clasp conforms to the magnetic object utilized or worn by the operator. For instance, if the operator wears a wrist band with a half-sphere magnet, then the magnet on the clasp should be half-inverted sphere. In another embodiment, if the wrist band magnet is flat then the clasp magnet will be flat.

The wrist can pull away from the magnetic tether to release the hand connection and free the operator's hand.

In a preferred embodiment, the clasps will be placed on the hoses, tubing, cords or cables and will stay on these items and be ready to connect. It will be pre-adjusted by the clinician for the best area on hoses or cords to clasp on for the best drag relief/weight relief. They will have a clasp that will grab on the hoses or cables permanently and will then just be brought to the wrist band and snap together magnetically. The clinician can easily switch from cord to a hose or vice versa because the connectors are already in place. They can be readjusted or removed at any time. This makes it a hands-free wristband. The clinician won't have to touch the cord or hose at any time. It just has to connect by placing the wristband next to the clasp magnet.

Adjustable Silicone Bracelet

In one embodiment, the invention utilizes an adjustable silicone utility band which magnetically tethers to the clasps described above.

This wristband is adjustable to fit all size wrist via multiple magnets embedded inside the ends of the wristband which will overlap to close and fit multiple sizes.

In one embodiment, the wristband is 10 inches long.

In one embodiment, the adjustable silicone utility band is approximately 1 inch thick. Preferably, the texture is soft, flexible and the band will conform to wrist comfortably, but yet grasps the skin on the wrist and does not slip upwards on the forearm.

The wrist bands will be made in three different sizes to ensure that the adjustable wrist band fits all wrists. In a preferred embodiment, the wrist band is large enough to fit the sizes of all operators via multiple small round openings in a row throughout the band on one side and a single closure piece on the other side at the end to push through one of the small openings of choice for closure.

One benefit of this magnetic wrist brand is that it is allows a “hands-free” control of the cords or hoses via the clasps described above.

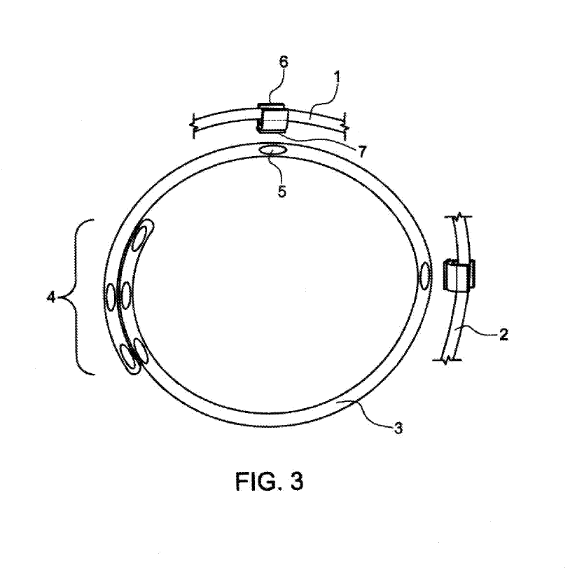

Reference is made to FIG. 3, which depicts the attachment of the adjustable silicone utility band (3) to both the (1) dental utility hose and (2) dental utility cord. In this example, an (4) overlapping series of magnets allows for the closure of the adjustable silicone utility band. In this example, a (5) flat magnet is employed on the adjustable silicone utility band with a corresponding (7) flat magnet on the (6) clasp secured to the utility cord.

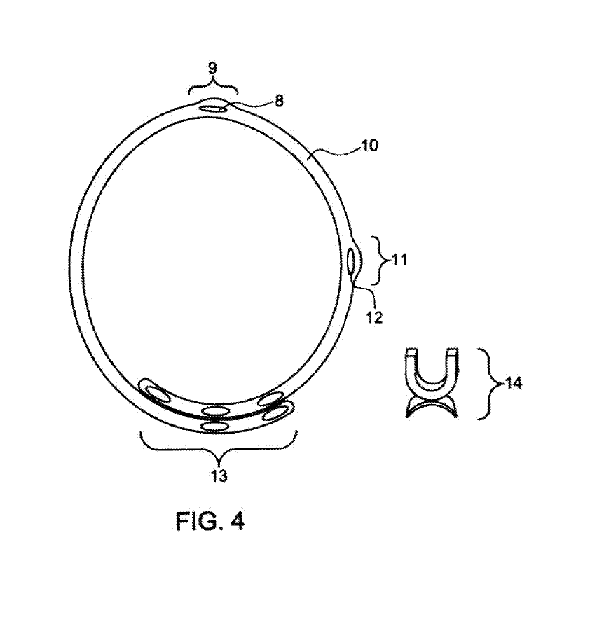

Reference is made to FIG. 4, which depicts an adjustable silicone utility band (10). In this example, an (13) overlapping series of magnets allows for the closure of the adjustable silicone utility band. In this example, a (8, 12) magnet is embedded in (9, 11) raised silicone in two places to secure to the cord and hoses, respectively. In this example, it is preferred that the cord or hose clasp employ an (14) inverted sphere magnet.

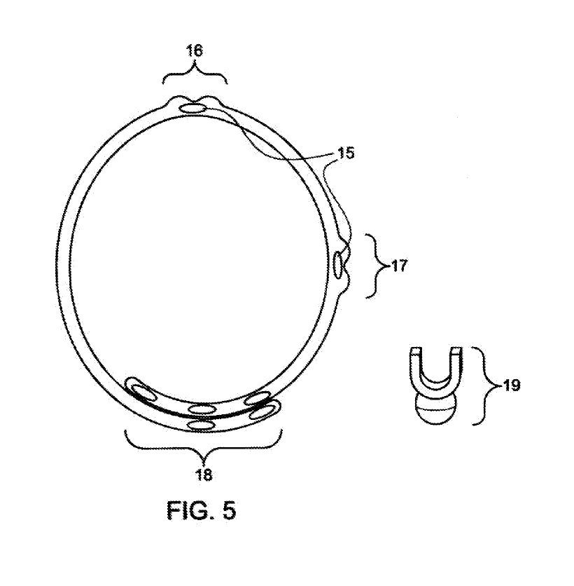

Reference is made to FIG. 5, which depicts an adjustable silicone utility band. In this example, an (18) overlapping series of magnets allows for the closure of the adjustable silicone utility band. In this example, a (15) magnet is embedded in (16, 17) grooved silicone in two places to secure to the cord and hoses, respectively. In this example, it is preferred that the cord or hose clasp employ an (19) spherical clasp.

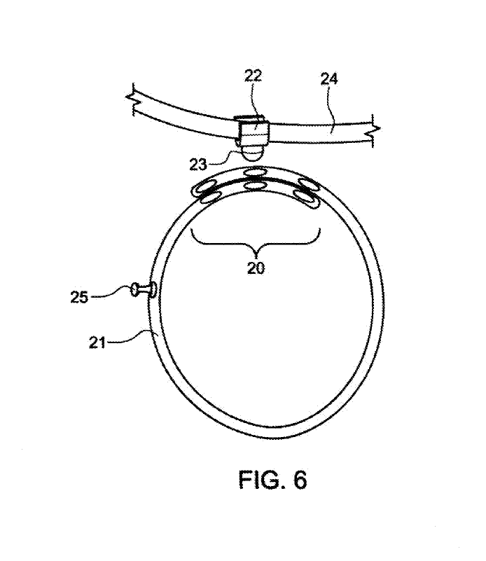

Reference is made to FIG. 6, which depicts an (21) adjustable silicone utility band. In this example, an (20) overlapping series of magnets allows for the closure of the adjustable silicone utility band. In this example, the same series of magnet which allow for the closure of the band can also secure to the (23) magnet attached to the (22) clasp which is secured to the (24) hose or cord. In this example, a (25) small peg is attached to the band which allows for the operator to move the band around the wrist.

This magnet allows a 360 degree rotational movement of the cord or hose relative to the wrist band. The hose can be moved in any direction because it can slide or twist along the magnet for any position of choice when adjusted by hand. This is a quick easy and efficient way for the dental hygienist to connect the hose or cord and work immediately without any hassle. The bracelet can also be adjusted by maneuvering/swaying the handle of the cavitron and handpieces in the direction of the position desired or can be moved by hand if chosen.

As a dental hygienist would understand, the cord magnet is used for such machines as the ultrasonic machines (either magnetostrictive or piezoelectric), air polishers, irrigators or any other machines with cords or cables. These cords are flexible, circular, and are approximately from 9-10 mm in outer circumference to 15-16 mm in outer circumference.

In a preferred embodiment, the cord or cable magnet is located at the top of the wrist and approximately in the center of the band. It employees a strong magnet (i.e., up to a 5 lb magnetic pull) to secure the connection between wrist band and interchangeable magnetic clasps already attached to cord or cable and ready to connect to the center magnet of the wrist band. This can also connect to the side magnet of the wrist band depending on the dental hygienist's choice.

In another embodiment, the side hose magnet will have adjustability for different sizing by making a long pocket with a slit opening within the wrist band and having access to the magnet. The elongated pocket enables different positions for different wrist sizes. They can open the slit and push the magnet from side to side to where they need it. The magnet will be securely in the pocket.

In a preferred embodiment, the band has stronger magnets in its center of the band for cord connection and another on the outer side of band for hose and tubing connection. The main magnets can be flat or a half sphere. A half sphere will be elevated on the wrist band giving a complete 360 degree rotation for connectors.

For the cord connection, it is preferable to leave magnet at the top of wrist and for hoses (or cords). The wrist band can be turned to side by a small hard silicone handle on the inner side of the band. The wrist band will then slide over by holding the handle between 2 fingers and maneuvering it over to the side. It will then be ready to connect the hose or tubings. Handle will be raised hard silicone that has either a sphere or widened flat end at the end that will be gripped by 2 fingers.

In a preferred embodiment, the hose magnet is located at the outer side of the wrist band. The hose or tubing of the dental unit handpieces are large in outer circumference and more of an oval shape. Compared to cords or cables, the hose or tubing are less flexible and heavier.

They must be held at the outer side of the wrist for connection and therefore a strong magnet or series of magnets must be placed within the wrist band at the outer side of the wrist.

It is envisioned that these magnets must be strong have a connection pull up to five pounds to ensure they stay connected during use. They will connect together by the pull of both magnets, the wrist band magnet and the clasp magnet on the hose.

In another embodiment, the wrist band has a closure. This closure acts as a handle to grab and rotate the wrist band to different positions on the wrist. It can be metal, plastic or silicone. This piece will go through the one of the wrist band holes to close. It will have a long neck with a wider circular/sphere end to put between fingers to hold on to and move to a different position on the wrist. It will stick up higher past the wrist band.

In another embodiment the universal wrist band will have equal size and strength magnets placed equally all throughout the band.

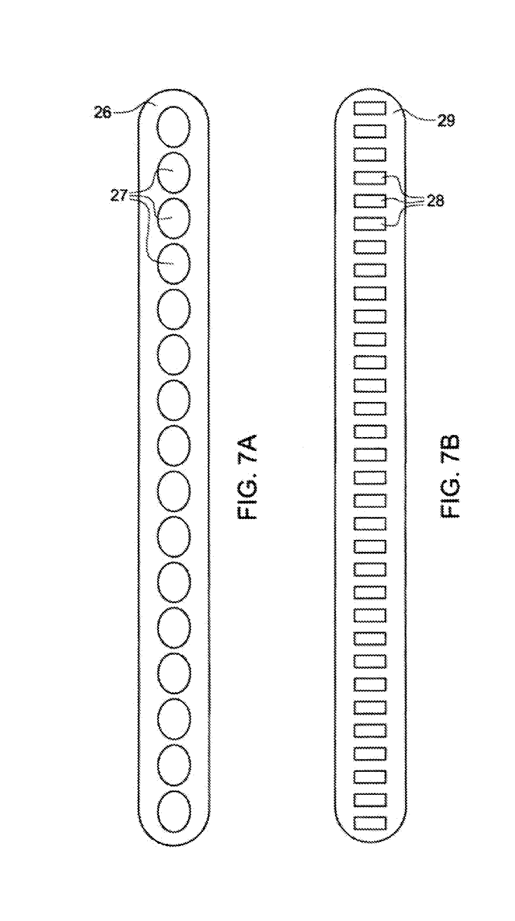

Reference is made to FIG. 7, which depicts two variants of the magnetic bracelet with magnets embedded throughout the magnet. The magnets can be any shape, but (27) circular magnets and (28) rectangular magnets are depicted in FIG. 7A and FIG. 7B, respectively.

The equal placement of magnets allows the cord and hose to be placed anywhere on the wrist band. The cord or hose can be slid across the wrist band to the optimal and preferred position as chosen by the dental hygienist. Placing the magnets side by side allows for flexibility and comfort on the wrist. In a preferred embodiment, there are many individual magnets in a row inside the band. These magnets will be separated but very close to each other to keep flexibility in the silicone wrist band.

As demonstrated in (4), (13), and (18) of FIGS. 3, 4, and 5, respectively, it is preferable that the wristband has have a magnetic closure.

The ends/straps of the wrist band will overlap each other and connect with a magnetic tether via multiple magnets embedded inside of the silicone.

In another embodiment, the adjustable silicone bands are differentiated by size using color coding or a numbering scheme.

In another embodiment, the wrist band contains magnets as well as other ferromagnetic metal where the cord and hose connect on the wrist band may be other types of metal to which clasp magnets connect.

Magnetic Silicone Rings

In one embodiment, the invention utilizes silicone rings with magnets embedded within.

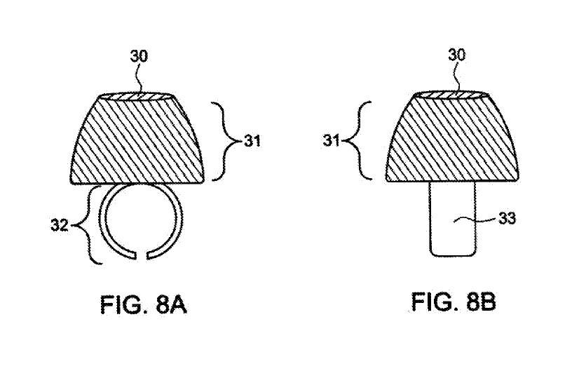

Reference is made to FIG. 8, which depicts two perspectives of a magnetic silicone ring, in particular a (8B) frontal view and a (9B) lateral view.

In this example, the ring has a (30) magnet secured at its top to connect to the magnetic clasp which is secured to the cord or hose. The remainder of the ring has a (31) silicone covering. In this example, item (32) is the ring portion to be placed on any finger (frontal view) and item (33) is the side view of the same to display its thickness.

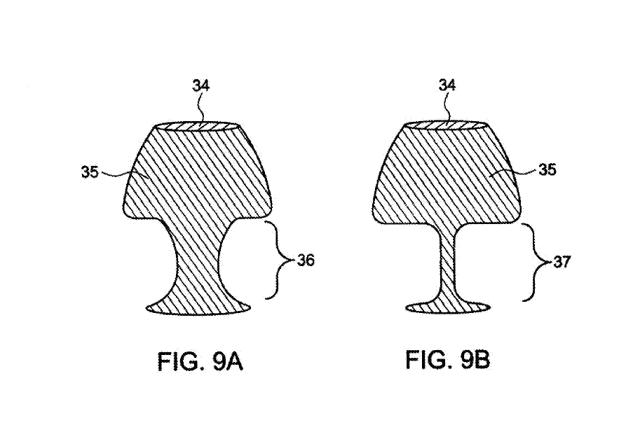

Reference is made to FIG. 9, which depicts two perspectives of a silicone ring with a magnet embedded within, in particular a (9A) lateral view with a (36) thick finger hold and a (9B) lateral view with a (37) thin finger hold

In this example, the ring has a (34) magnet embedded within a (35) silicone covering. The magnet allows allows for it to tether to the magnetic clasp which is secured to the cord or hose.

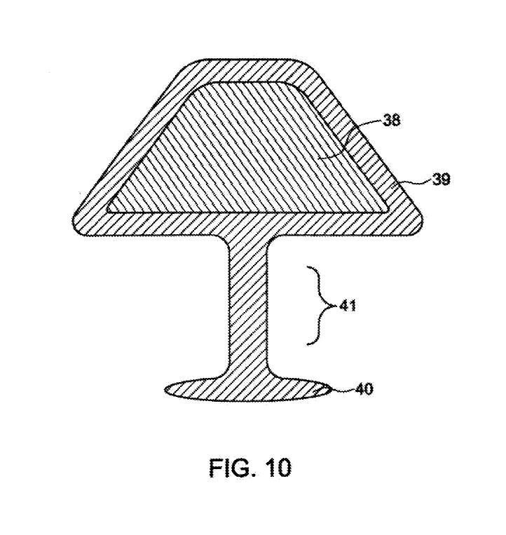

Reference is made FIG. 10, which depicts a lateral view of a silicone ring with a large magnet. In particular, the ring has a (38) large embedded magnet which is covered by a (39) silicone covering. Item (40) depicts the base of the finger grip while Item (41) depicts the finger grip.

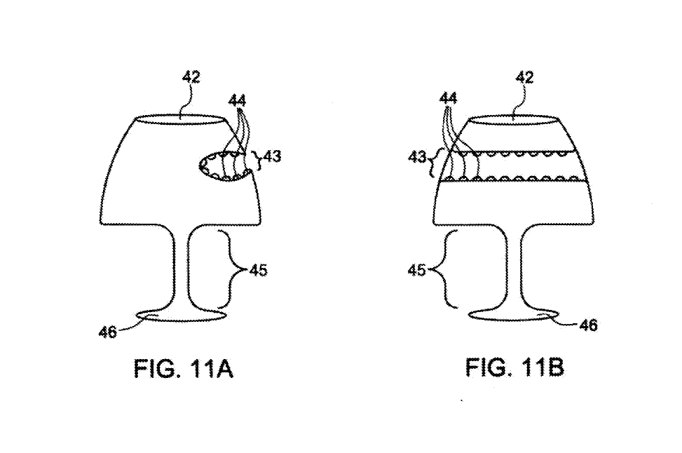

Reference is made to FIG. 11, which depicts optional variants of the magnetic silicone ring with teeth-reinforced openings. In FIG. 11A, the teeth-reinforced opening is along the same axis of the finger hold and in FIG. 11B, the teeth-reinforced opening is perpendicular to the axis of the finger hold.

In these examples, item (42) depicts a flat, circular magnet affixed to the ring which tethers to the magnet on the clasp affixed to the cord or hose. Item (43) is an opening portion filled with a (44) number of silicone teeth. These enable the clinician to hold a piece of cotton gauze. Item (45) is the fingerhold as viewed perpendicular to a finger, and item (46) is the circular or oval shaped bottom.

Finger Grip

In one embodiment, the invention utilizes finger grips with magnets embedded within.

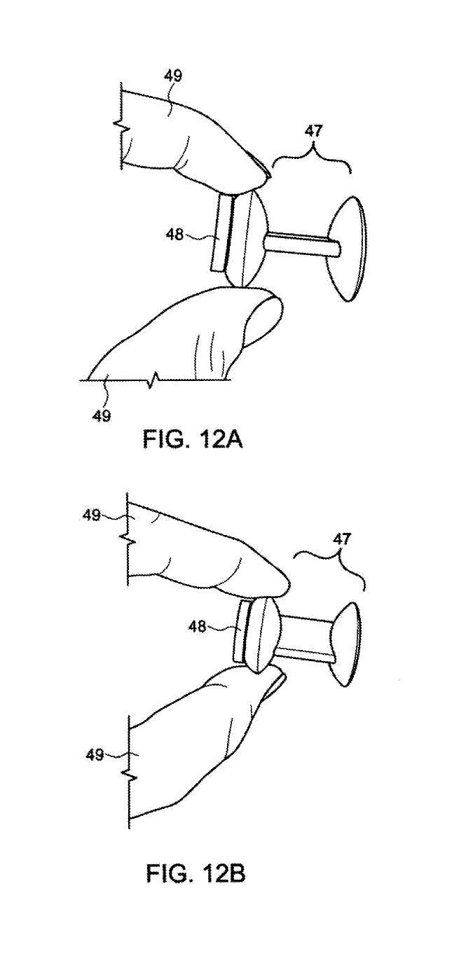

Reference is made to FIG. 12, which depicts a fingergrip with a flat magnet secured to its top. The two views are a frontal view (FIG. 12A) and a lateral view (FIG. 12B).

In these examples, item (47) depicts the finger grip and a (48) magnet. The fingergrip utilizes a commercially Nupro (R) fingergrip a securing to its dorsal portion a magnet from those suitably described above. In this example, the (48) magnet is a flat magnet. Item (49) depicts the fingers of a dental hygienist for perspective.

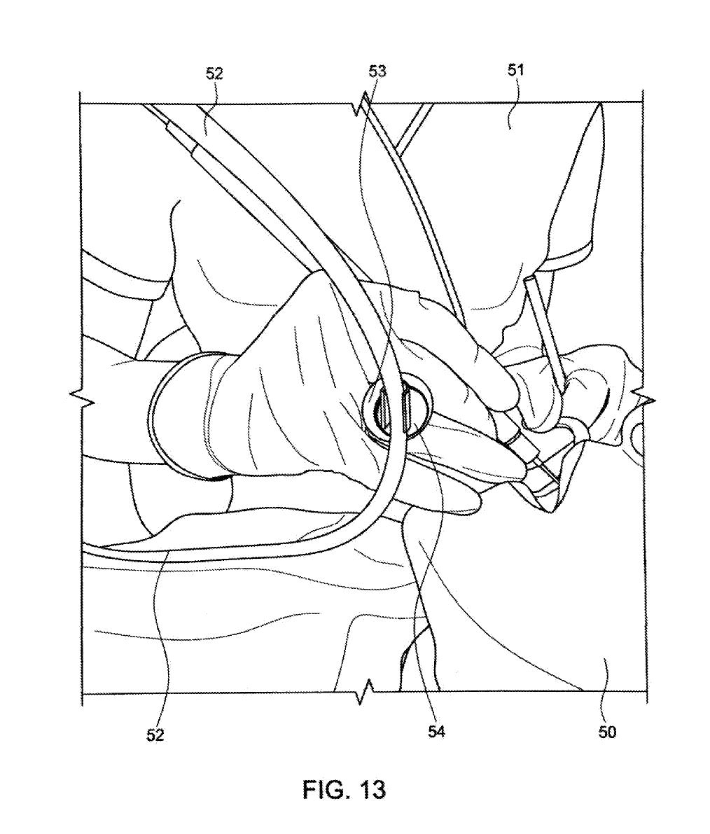

FIG. 13 depicts a perspective view of the finger support with a magnet in use by a dental hygienist. Item (50) is the patient, item (51) is the dental hygienist, item (52) is the hose or tube, examples of which are described above, item (53) is the fingergrip as currently described, and item (54) is the magnet attached the fingergrip.

It would be recognized by one of skill in the art this perspective view depicts the use of embodiment of the invention. One of skill in the art would immediately recognize that other embodiments (i.e., the adjustable bracelet and the ring) can be suitably employed during use by the clinician or dental hygienist.

Kits

The invention also comprises a kit of the components of the adjustable silicone utility band and the clasps described above.

The kits can be selected from the group of items described above.

All components of the invention can be disinfected with OSHA compliant disinfectants. They can be wiped down and sprayed for the recommended amount of time of each of the individual disinfectant sprays. The sealed silicone components will allow to clean properly. The invention is autoclavable and can be autoclaved if desired.

The foregoing description comprises illustrative embodiments of the present invention.

As will be appreciated, the foregoing objects and examples are exemplary and embodiments need not meet all or any of the foregoing objects, and need not include all or any of the exemplary features described herein. Additional aspects and embodiments within the scope of the claims will be devised by those having skill in the art based on the teachings set forth herein.

While the invention has been described in connection with what are considered to be exemplary embodiments, it is to be understood that the invention is not limited to the disclosed embodiments, but on the contrary, is intended to cover various modifications and equivalent arrangements included within the spirit and scope of the appended claims.

I claim:

1. A means for magnetically tethering a hand to a utility tube or hose, comprising:
(a) an adjustable silicone wrist band containing at least one magnet, and
(b) a clasp secured on the utility tube containing at least one magnet.

2. A kit comprising
(a) at least one adjustable silicone wrist band, and
(b) at least one clasp.

3. The kit of claim 2 wherein the adjustable wrist band contains at least one magnet.

4. The kit of claim 2 wherein the clasp contains at least one magnet.
